(19) United States
(12) Patent Application Publication
(10) Pub. No.: US 2021/0173037 A1
(43) Pub. Date: Jun. 10, 2021

(54) APPARATUS AND METHOD FOR LOCATING A MOBILE DEVICE IN A NETWORK SYSTEM

(71) Applicant: HUAWEI TECHNOLOGIES CO., LTD., Shenzhen (CN)

(72) Inventors: Chengsheng QUE, Shanghai (CN); Ganghua YANG, Shanghai (CN)

(21) Appl. No.: 17/147,044

(22) Filed: Jan. 12, 2021

Related U.S. Application Data
(63) Continuation of application No. PCT/EP2018/069173, filed on Jul. 13, 2018.

(51) Int. Cl. G01S 5/02; H04W 88/02; G01S 5/06

(52) U.S. Cl. CPC G01S 5/021; G01S 5/06; H04W 88/02

(57) ABSTRACT

The disclosure relates to a method and an apparatus for locating a mobile device in a network system. For each pair of anchor stations, a receiver channel delay difference of receiving times of a first signal transmitted by a different anchor station and received at the anchor stations is determined. This receiver channel delay difference is used for compensating time difference of arrival among the mobile device and the pair of anchor stations. The compensated time difference of arrivals among the mobile device and the pair of anchor stations are used to determine the position of the mobile device.

### CROSS-REFERENCE TO RELATED APPLICATIONS

This application is a continuation of International Application No. PCT/EP2018/069173, filed on Jul. 13, 2018, the disclosure of which is hereby incorporated by reference in its entirety.

### TECHNICAL FIELD

The disclosure relates to an apparatus and a method for locating a mobile device in a network system. Furthermore, the disclosure also relates to a corresponding network system, a computer program product and a computer readable storage medium.

### BACKGROUND

An Indoor Positioning System (IPS) is a network system used to wirelessly locate objects, such as a mobile device, or people inside a building or in dense industrial areas. A special solution is needed since global positioning systems (GPS) are typically not suitable to establish indoor locations as they need an unobstructed line of sight (LOS) to four or more GPS satellites. Microwaves will be attenuated and scattered by roofs, walls and other objects and multiple reflections at surfaces cause multipath propagation serving for uncontrollable errors.

Time of flight, ToF, is the amount of time a signal takes to propagate from a transmitter to a receiver. Because the signal propagation rate is constant and known, the travel time of a signal can be used directly to calculate the distance between the transmitter and the receiver. Multiple (in GPS at least four satellites) measurements or multiple anchor stations can be combined with trilateration to find the location of a mobile device.

A trilateration method based on Time Difference of Arrival, TDOA, is a common scheme for locating a mobile device in a network system. In the network system, three or more anchor stations are used. The position of the mobile device is estimated according to the time difference of arrivals from the mobile device to each anchor station respectively. However, in commercial systems, receiver channel delays are different for different anchor stations because of manufacture process of these devices. Different receiver channel delays (non-synchronization) leads to inaccurate localization when using a TDOA-based method to locate the mobile device.

### SUMMARY

An objective of the disclosure is to provide a solution which mitigates the drawbacks of conventional device location techniques.

The above and further objectives are solved by the subject matter of the independent claims. Further advantageous embodiments of the disclosure can be found in the dependent claims.

The disclosure aims at improving the accuracy for locating the mobile device by reducing different receiver channel delays among different anchors, or base stations, in the network system.

The term “RF” refers to radio frequency of any appropriate wavelength.

The term “anchor station” refers to a base transmitter whose location is known and is used as a reference location in determining the location of the mobile device, e.g. a base station, BS, or an access point, AP.

The term “mobile device” refers to a device, such as a mobile station, whose location is being identified.

The term “first radio frequency signal” refers to a radio frequency signal transmitted (broadcasted) from one anchor station (e.g., a base station or an access point), and received by anchor stations located in the vicinity of the transmitting anchor station.

The term “second radio frequency signal” refers to a radio frequency signal transmitted from a mobile device (e.g., a terminal device), which is being received at anchor stations in the vicinity of the mobile device.

According to a first aspect of the disclosure, the above mentioned and other objectives are achieved with a method for locating a mobile device in a network system. The network system comprises a plurality of anchor stations. The method comprises the steps: for each pair of anchor stations Aᵢ and Aⱼ: determining a receiver channel delay difference, ΔT_{rx(A}_{ᵢ}_{,A}_{ⱼ}₎ of receiving times of a first signal transmitted by a different anchor station Aₖ and received at both anchor stations Aᵢ and Aⱼ, wherein i, j, k are integers, i, j, k≥1, and i≠j≠k; determining a time difference of arrival, ΔT_{(MD,A}_{ᵢ}_{,A}_{ⱼ}₎, of receiving times of a second signal transmitted by the mobile device to the pair of anchor stations Aᵢ and Aⱼ; obtaining a compensated time difference of arrivals Comp_ΔT_{(MD,A}_{ᵢ}_{,A}_{ⱼ}₎ based on the time difference of arrival, ΔT_{(MD,A}_{ᵢ}_{,A}_{ⱼ}₎ and the receiver channel delay difference ΔT_{rx(A}_{ᵢ}_{,A}_{ⱼ}₎; determining the location of the mobile device based on the compensated time difference of arrivals Comp_ΔT_{(MD,A}_{ᵢ}_{,A}_{ⱼ}₎.

It should be noted that the determination of the receiver channel delay difference ΔT_{rx(A}_{ᵢ}_{,A}_{ⱼ}₎ and the determination of the time difference of arrival ΔT_{(MD,A}_{ᵢ}_{,A}_{ⱼ}₎ can be processed one after another, or processed concurrently.

An advantage of the method according to the first aspect is that by compensating the time difference of arrival, of a RF signal propagated from the mobile device to the pair of anchor stations, by the receiver channel delay difference between the two anchor stations, influences of different receiver channel delay at different anchor stations are reduced, improving thus the accuracy of estimation of the position of the mobile device.

In an implementation form of the method according to the first aspect, the receiver channel delay difference ΔT_{rx(A}_{ᵢ}_{,A}_{ⱼ}₎ is determined as follows: a pair of time of arrivals T_{(A}_{ₖ}_{A}_{ᵢ}₎ and T_{(A}_{ₖ}_{A}_{ⱼ}₎ are received, wherein T_{(A}_{ₖ}_{A}_{ᵢ}₎ and T_{(A}_{ₖ}_{A}_{ⱼ}₎ specify receiving times of the first signal transmitted by anchor station Aₖ and received at anchor stations Aᵢ and Aⱼ respectively. The difference of receiver channel delays ΔT_{rx(A}_{ᵢ}_{,A}_{ⱼ}₎ from the pair of received time of arrivals T_{(A}_{ₖ}_{A}_{ᵢ}₎ and T_{(A}_{ₖ}_{A}_{ⱼ}₎ is then determined.

In an implementation form of the method according to the first aspect, the time difference of arrival, ΔT_{(MD,A}_{ᵢ}_{,A}_{ⱼ}₎ is determined as follows: a pair of time of arrivals T_{(MD,A}_{ᵢ}₎ and T_{(MD,A}_{ⱼ}₎ are respectively received from anchor stations Aᵢ and Aⱼ. The time of arrivals T_{(MD,A}_{ᵢ}₎ and T_{(MD,A}_{ⱼ}₎ specify receiving times of the second signal transmitted by the mobile device and received at the pair of anchor stations Aᵢ and Aⱼ respectively. The time difference of arrival ΔT_{(MD,A}_{ᵢ}_{,A}_{ⱼ}₎ is determined from the pair of time of arrivals T_{(MD,A}_{ᵢ}₎ and T_{(MD,A}_{ⱼ}₎.

In an implementation form of the method according to the first aspect, a compensated time difference of arrivals Comp_ΔT_{(MD,A}_{ᵢ}_{,A}_{ⱼ}₎ is obtained by subtracting the receiver channel delay difference ΔT_{rx(A}_{ᵢ}_{,A}_{ⱼ}₎ from the determined time difference of arrival ΔT_{(MD,A}_{ᵢ}_{,A}_{ⱼ}₎.

In an implementation form of the method according to the first aspect, the location of the mobile device is determined based on the compensated time difference of arrivals Comp_ΔT_{(MD,A}_{ᵢ}_{,A}_{ⱼ}₎ as follows: N different pairs of anchor stations are chosen from the plurality of anchor stations, wherein N is an integer and N≥2. N compensated time difference of arrivals are obtained which correspond to the N different pairs of anchor stations, respectively. The location of the mobile device is determined according to the N compensated time difference of arrivals. In particular, the location of the mobile device is determined by multiplication of the compensated time difference of arrivals and the speed of light.

An advantage with this implementation form is that multiple compensated time difference of arrivals are obtained, and these can be used in locating of the mobile device, further improving the accuracy of device localization.

The time of arrivals T_{(A}_{ₖ}_{,A}_{ᵢ}₎ and T_{(A}_{ₖ}_{,A}_{ⱼ}₎, respectively, comprises a transmitting time T_{A}_{ₖ} for the first signal transmitted by anchor station Aₖ; propagation times T_{AIR(A}_{ₖ}_{,A}_{ᵢ}₎ and T_{AIR(A}_{ₖ}_{,A}_{ⱼ}₎, respectively, for the first signal being propagated from anchor station Aₖ to the pair of anchor stations Aᵢ and Aⱼ, respectively; and receiving channel delays T_{rx(A}_{ᵢ}₎ and T_{rx(A}_{ⱼ}₎, respectively, of receiving time of the first signal transmitted by anchor station Aₖ and received at anchor station Aᵢ and Aⱼ, respectively; in particular,

T_{(A}_{ₖ}_{,A}_{ᵢ}₎=T_{A}_{ₖ}+T_{AIR(A}_{ₖ}_{,A}_{ᵢ}₎+T_{rx(A}_{ᵢ}₎

T_{(A}_{ₖ}_{,A}_{ⱼ}₎=T_{A}_{ₖ}+T_{AIR(A}_{ₖ}_{,A}_{ⱼ}₎+T_{rx(A}_{ⱼ}₎.

These times of arrivals are determined by each pair of receiving anchor stations according to the above formula.

In an implementation form of the method according to the first aspect, if the to-be-determined position of the mobile device is in two dimension, a minimum number for the pairs of anchor stations is 2; and if the to-be-determined position of the mobile device is in three dimension, a minimum number for the pairs of anchor stations is 3.

In an implementation form of the method according to the first aspect, if N is greater than the minimum number, the position of the mobile device can be determined based on the N compensated time difference of arrivals, the positions of the N different pairs of anchor stations according to a linear least square algorithm.

An advantage with this implementation form is that by using the linear least square algorithm, the determination of the position of the mobile device can be more accurate.

In an implementation form of the method according to the first aspect, the first signal and the second signal are two different radio frequency signals.

According to a second aspect of the disclosure, the above mentioned and other objectives are achieved with an apparatus for locating a mobile device in a network system. The network system comprises a plurality of anchor stations. The apparatus can be a proceeding module which can be deployed in one of the plurality of anchor stations. The apparatus can be also realized with a separate device, for example an application server. For the skilled person in the art, it is to be understood that there are a plurality of modules to implement the functions. In particular, the apparatus is configured to:

for each pair of anchor stations Aᵢ and Aⱼ:
determine a receiver channel delay difference, ΔT_{rx(A}_{ᵢ}_{,A}_{ⱼ}₎ of receiving times of a first signal transmitted by a different anchor station Aₖ and received at both anchor stations Aᵢ and Aⱼ, wherein i, j, k are integers, i, j, k≥1, and i≠j≠k;
determine a time difference of arrival, ΔT_{(MD,A}_{ᵢ}_{,A}_{ⱼ}₎, of receiving times of a second signal transmitted by the mobile device to the pair of anchor stations Aᵢ and Aⱼ;
obtain a compensated time difference of arrivals Comp_ΔT_{(MD,A}_{ᵢ}_{,A}_{ⱼ}₎ based on the time difference of arrival. ΔT_{(MD,A}_{ᵢ}_{,A}_{ⱼ}₎ and the receiver channel delay difference ΔT_{rx(A}_{ᵢ}_{,A}_{ⱼ}₎;
determine the location of the mobile device based on the compensated time difference of arrivals Comp_ΔT_{(MD,A}_{ᵢ}_{,A}_{ⱼ}₎.

The apparatus according to the second aspect can be extended into implementation forms corresponding to the implementation forms of the method according to the first aspect. Hence, an implementation form of the apparatus comprises the feature(s) of the corresponding implementation form of the method.

The advantages of the methods according to the second aspect are the same as those for the corresponding implementation forms of the first apparatus according to the first aspect.

The disclosure also relates to a network system, comprises a mobile device, an apparatus according to any of second aspect of the disclosure, and a plurality of anchor stations.

The disclosure also relates to a computer program, characterized in program code, which when run by at least one processor causes said at least one processor to execute a method according to any of first aspect of the disclosure.

Further, the disclosure also relates to a computer program product comprising a computer readable medium and said mentioned computer program, wherein said computer program is included in the computer readable medium, and comprises of one or more from the group: ROM (Read-Only Memory), PROM (Programmable ROM), EPROM (Erasable PROM), Flash memory, EEPROM (Electrically EPROM) and hard disk drive.

Further, the disclosure also relates to a computer readable storage medium comprising computer program code instructions, being executable by a computer, for performing a method according to any of first aspect of the disclosure when the computer program code instructions runs on a computer.

Further applications and advantages of the embodiments of the disclosure will be apparent from the following detailed description.

### BRIEF DESCRIPTION OF THE DRAWINGS

The appended drawings are intended to clarify and explain different embodiments of the disclosure, in which:

FIG. 1 shows a network system according to an embodiment of the disclosure;

FIG. 2 shows a timeline flowchart for a method according to an embodiment of the disclosure;

FIG. 3 shows a server according to an embodiment of the disclosure.

### DETAILED DESCRIPTION

Illustrative embodiments of method, apparatus, and program product for efficient packet transmission in a communication system are described with reference to the figures. Although this description provides a detailed example of possible implementations, it should be noted that the details are intended to be exemplary and in no way limit the scope of the application.

Moreover, an embodiment/example may refer to other embodiments/examples. For example, any description including but not limited to terminology, element, process, explanation and/or technical advantage mentioned in one embodiment/example is applicative to the other embodiments/examples.

In order to reduce the influence of different receiver channel delays corresponding to different anchor stations in the process of locating a mobile device, an embodiment for an optimized triangulation method based on TDOA is provided.

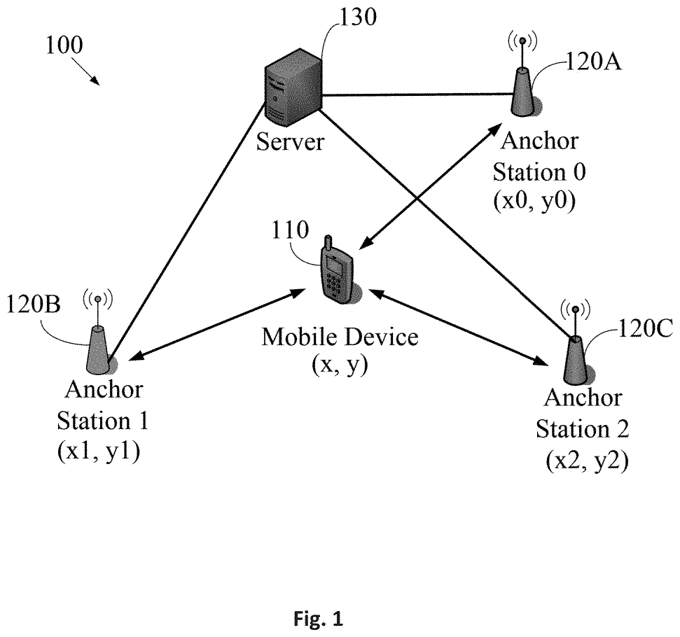

FIG. 1 shows a network system 100 according to an embodiment of the disclosure. The network system 100 comprises a mobile device 110 (e.g. a terminal device, user equipment) and three anchor stations 120A-120C (e.g. base stations or access points), and a server 130. For simplicity, the network system 100 shown in FIG. 1 only comprises one mobile device 110 and three anchor station 120A-120C. However, the network system 100 may comprise any number of mobile devices 110 and any number of anchor stations 120 without deviating from the scope of the disclosure. The server 130 can be implemented with a separate apparatus (e.g., an application server device), or one or a plurality of modules integrated in one of the three anchor stations 120A-120C or integrated in another anchor station (now shown in FIG. 1) except the three anchor stations 120A-120C.

In the embodiment shown in FIG. 1, the mobile device 110 is in connected mode with the three anchor stations 120A-120C and three radio links (RL) are configured between the mobile device 110 and each of the three anchor stations 120A-120C. The radio links (RL) may be configured to work in an uplink (UL) mode, or in a downlink (DL) mode.

In the embodiment shown in FIG. 1, the server 130 is connected with the three anchor stations 120A-120C via wireless connection, wired connection or both of wireless and wired connections.

To determine position of the mobile device 110 (e.g., denoted as (x,y)), a plurality of anchor stations are selected as reference positions. The positions of the anchor stations is known in advance. Just as an example, positions of the three anchor stations 120A-120C are given as (x0, y0) for anchor station_0 120A, (x1, y1) for anchor station_1 120B, and (x2, y2) for anchor station_2 120C.

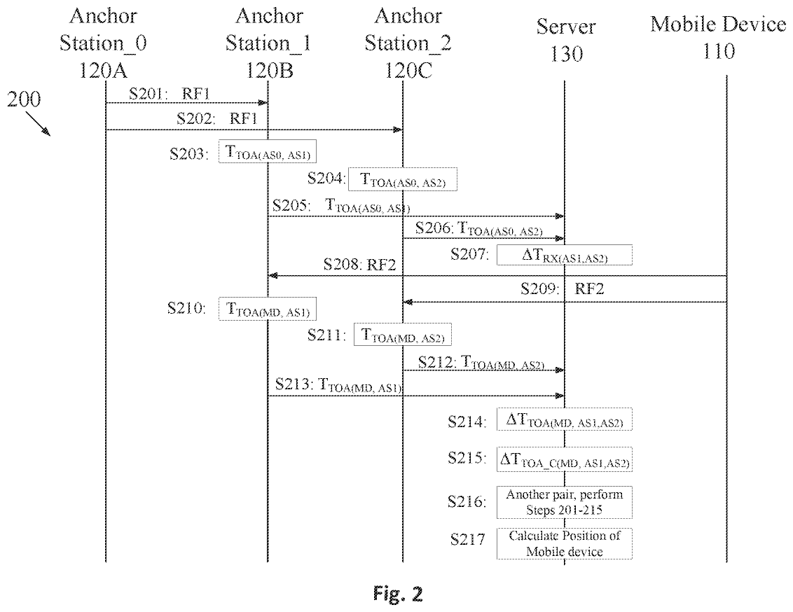

FIG. 2 shows a timeline flow chart of a method 200 for locating a mobile device 110 in a network system 100 according to an embodiment of the disclosure.

In the embodiment of the disclosure, N different pairs of anchor stations Aᵢ and Aⱼ from the plurality of anchor stations are selected as receivers, wherein i, j are integers, i, j≥1, and i≠j. For each pair of anchor stations Aᵢ and Aⱼ, another different anchor station Aₖ is selected as a transmitter, wherein k are integers, k≥1, and i≠j≠k.

It may be known that, by using a set of three anchor stations (e.g., anchor_1, anchor_2, anchor_3), the position of the mobile device 110 can be also determined. In the three anchor stations, at most three different pairs of anchor stations can be chosen as receivers (e.g., a first pair is anchor_1 and anchor_2, a second pair is anchor_1 and anchor_3, and a third pair is anchor_2 and anchor_3), and for each pair of anchor stations, another different anchor station in the set may be chosen as a transmitter.

For simplicity, FIG. 2 shows an embodiment with a set of three anchor stations, i.e. anchor station_0 120A, anchor station_1 120B, anchor station_2 120C. Among them, anchor station_0 120A is chosen as a transmitter, and the other two anchor stations (i.e., anchor station_1 120B, anchor station_2 120C) are chosen as receivers.

Steps 201 (S201) and 202 (S202): a first signal (e.g. a radio frequency signal, RF1) is transmitted from anchor station_0 (i.e. a transmitter) 120A to anchor station_1 120B (i.e. a first receiver) and anchor station_2 120C (i.e. a second receiver), respectively.

In the implementation, anchor station_0 120A broadcasts the first signal (e.g. a radio frequency signal, RF1) in an omnidirectional form.

Steps 203 (S203) and 204 (S204): after receiving the first signal RF1, the first and the second receiver anchor stations anchor station_1 120B, and anchor station_2 120C, record the respective time of arrivals T_{TOA(AS0, AS1)} and T_{TOA(AS0, AS2)}. The time of arrivals T_{TOA(AS0, AS1)} and T_{TOA(AS0, AS2)} specify receiving time of the first signal (e.g., the radio frequency signal RF1) transmitted by anchor station_0 120A and received at anchor station_1 120B and anchor station_2 120C respectively.

Each receiving anchor station ASᵢ (i=1, 2 . . . ,) determines the corresponding receiving time of arrival T_{TOA(AS0,AS1)} of the first signal (e.g. the first radio frequency signal RF1) sent by AS₀ based on three components.
(1) a transmitting time T_{Tx(AS0)}: refers to a time delay, for anchor station_0 120A, of transmitting the first signal (e.g., the radio frequency signal RF1).
(2) a propagation time T_{air(AS0,ASi)}: refers to a time for the first signal (e.g., the radio frequency signal RF1), being propagated from anchor station_0 120A to the receiving anchor station ASᵢ (in FIG. 1, anchor station_1 120B and anchor station_2 120C).

The positions of anchor stations are pre-determined. In the implementation, this propagation time is determined by dividing the distance between anchor stations by the speed of the light.

(3) a receiver channel delay T_{Rx(ASi)}: refer to a time delay for the receiving anchor station ASᵢ (in FIG. 1, anchor station_1 120B or anchor station_2 120C), to receive the first signal (e.g. the radio frequency signal RF1).

That is, the time of arrival T_{TOA(AS0,ASi)} of the signal broadcasted by the anchor station AS₀ and received at ASᵢ can be determined as:

T_{TOA(AS0,ASi)}=T_{Tx(AS0)}+T_{air(AS0,ASi)}+T_{Rx(ASi)},i=1, 2, . . . .

For two receiving anchor stations(AS₀, and AS₁), the time of arrivals are determined as:

T_{TOA(AS0,AS1)}=T_{Tx(AS0)}+T_{air(AS0,AS1)}+T_{Rx(AS1)}

T_{TOA(AS0,AS2)}=T_{Tx(AS0)}+T_{air(AS0,AS2)}+T_{Rx(AS2)} \textcircled{1}

Steps 205 (S205) and 206 (S206): the time of arrivals T_{TOA(AS0, AS1)} and T_{TOA(AS0, AS2)} are transmitted from anchor station_1 120B and anchor station_2 120C to the server 130 respectively.

Step 207 (S207): a receiver channel delay difference for the two receivers (i.e. anchor station_1 120B and anchor station_2 120C) ΔT_{RX(AS1, AS2)} is determined according to the time of arrivals T_{TOA(AS0, AS1)} and T_{TOA(AS0, AS2)}.

In the implementation, the receiver channel delay difference ΔT_{TX(AS1, AS2)} can be specifically determined based on the equation \textcircled{1}:

ΔT_{RX(AS1,AS2)}=T_{RX(AS1)}−T_{RX(AS2)}=T_{TOA(AS0,AS1)}−T_{TOA(AS0,AS2)}+T_{air(AS0,AS2)}−T_{air(AS0,AS1)} \textcircled{2}

Steps 208 (S208) and 209 (S209), a second signal (e.g. a radio frequency signal, RF2) is transmitted from the mobile device 110 to anchor station_1 120B (i.e. the first receiver) and anchor station_2 120C (i.e. the second receiver) simultaneously.

In the implementation, the mobile device 110 transmits the second signal (e.g. a radio frequency signal, RF2) in an omnidirectional form.

Steps 210 (S210) and 211 (S211): the second signal (e.g. the radio frequency signal RF2) is received by anchor station_1 120B and anchor station_2 120C respectively. The time of arrivals T_{TOA(MD, AS1)} and T_{TOA(MD, AS2)} are recorded. The time of arrivals T_{TOA(MD, AS1)} and T_{TOA(MD, AS2)} specify transmitting time for the second signal (e.g. the radio frequency signal RF2) transmitted from the mobile device 110 to anchor station_1 120B and anchor station_2 120C respectively.

Each receiving anchor station ASᵢ (i=1, 2 . . . ,) determines the corresponding time of arrival T_{TOA(MD, ASi)} for the second signal (e.g. the radio frequency signal. RF2) based on the three components as follows:
(1) a transmitting time T_{Tx(MD)} for the mobile device 110 to transmit the second signal (e.g. the radio frequency signal RF2).
(2) a propagation time T_{air(MD,ASi)}: for the second signal (e.g. the radio frequency signal RF2) being propagated from the mobile device 110 to the receiving anchor station ASᵢ (in FIG. 1, anchor station_1 120B or anchor station_2 120C).
(3) a receiver channel delay T_{Rx(ASi)}: refer to a time delay, for the receiving anchor station ASᵢ (in FIG. 1, anchor station_1 120B or anchor station_2 120C), to receive the second signal (e.g. the radio frequency signal RF2).

That is, the time of arrival T_{TOA(MD,ASi)} of the signal broadcasted by the anchor station MD and received at ASᵢ can be determined as:

T_{TOA(MD,ASi)}=T_{Tx(MD)}+T_{air(MD,ASi)}+T_{Rx(ASi)},i=1,2, . . . .

For two receiving anchor stations(AS₁, and AS₂), the time of arrivals are determined as:

T_{TOA(MD,AS1)}=T_{Tx(MD)}+T_{air(MD,AS1)}+T_{Rx(AS1)}

T_{TOA(MD,AS2)}=T_{Tx(MD)}+T_{air(MD,AS2)}+T_{Rx(AS2)} \textcircled{3}

Steps 212 (S212) and 213 (S213): the time of arrivals T_{TOA(MD, AS1)} and T_{TOA(MD, AS2)} are transmitted from anchor station_1 120B and anchor station_2 120C to the server 130 respectively.

Step 214 (S214): a time difference of arrival ΔT_{TOA(MD,AS1,AS2)} is obtained. The time difference of arrival ΔT_{TOA(MD,AS1,AS2)} specifies a difference of time of arrival, TDOA for the second signal (e.g. the radio frequency signal RF2) transmitted from the mobile device 110 to anchor station_1 120B and anchor station_2 120C respectively.

In the implementation, the difference of time of arrivals ΔT_{TOA(MD,AS1,AS2)} can be determined based on the equation \textcircled{3}:

ΔT_{TOA(MD,AS1,AS2)}=T_{TOA(MD,AS1)}−T_{TOA(MD,AS2)}=(T_{air(MD,AS1)}−T_{air(MD,AS2)})+(T_{Rx(MD,AS1)}−T_{Rx(MD,AS2)})=ΔT_{air(MD,AS1,AS2)}+T_{Rx(AS1,AS2)} \textcircled{4}

In the equation \textcircled{4}, the first component denoted as ΔT_{air(MD,AS1,AS2)} refers to a time difference for the second signal (e.g. the radio frequency signal RF2) being propagated over the air from the mobile device 110 to anchor station_1 120B and anchor station_2 120C separately. The second component denoted as ΔT_{Rx(AS1,AS2)} refers to a receiver channel delay difference of receiving times for anchor station_1 120B and anchor station_2 120C, which has been obtained in equation \textcircled{2}.

Step 215 (S215): a compensated time difference of arrival ΔT_{TOA_C(MD, AS1,AS2)} is determined based on the corresponding difference of receiving times ΔT_{RX(AS1,AS2)} and the estimated time difference of arrival ΔT_{TOA(MD,AS1,AS2)}.

In the implementation, the compensated time difference of arrivals ΔT_{TOA_C(MD, AS1,AS2)} can be determined based on the equation \textcircled{5}:

ΔT_{TOA_C(MD,AS1,AS2)}=ΔT_{air(MD,AS1,AS2)}=ΔT_{TOA(MD,AS1,AS2)}−ΔT_{Rx(AS1,AS2)} \textcircled{5}

In equation \textcircled{5}, the receiver channel delay difference ΔT_{Rx(AS1,AS2)} of receiving times for anchor station_1 120B and anchor station_2 120C can be obtained in equation \textcircled{2}. The time difference of arrival ΔT_{TOA(MD,AS1,AS2)} can be determined based on different known algorithms. Just as an example, in orthogonal frequency-division multiplexing, OFDM systems, assuming hₖ and hₖ₊₁ are the received channel of sub-carrier k and k+1 respectively, and h*ₖ specifies conjugate of hₖ. Δf is the sub-carrier space between two adjacent sub-carriers k and k+1, τ is the time of arrival for a sub-carrier (e.g. sub-carrier k or k+1) being propagated from the mobile device 110 to an anchor station (e.g. anchor station_1 120B or anchor station_2 120C). Then the time of arrival τ can be determined as, wherein arg(A) denotes the phase difference of A:

$$τ = \frac{arg ( {h}_{k + 1} * {h}_{k}^{*} )}{2 π Δ f}$$

The time difference of arrival TDOA ΔT_{TOA(MD,AS1,AS2)} can be determined as:

$$Δ {T}_{TOA ( MD , AS 1 , AS 2 )} = Δ τ = {τ}_{AS 1} - {τ}_{AS 2} = \frac{{arg ( {h}_{k + 1} * {h}_{k}^{*} )}_{AS 1}}{2 π Δ f} - \frac{{arg ( {h}_{k + 1} * {h}_{k}^{*} )}_{AS 2}}{2 π Δ f}$$

From FIG. 1, assuming position of the mobile device denoted as(x, y), the positions of the anchor stations (i.e. anchor station_0, anchor station_1, and anchor station_2) can be pre-determined and they are denoted as respectively: (x₀, y₀), (x₁, y₁), (x₂, y₂).

Based on Steps 201 to 215, an equation can be obtained as follows, C denotes the speed of light:

\sqrt{(x−x₁)²+(y−y₁)²}−\sqrt{(x−x₂)²+(y−y₂)²}=ΔT_{air(MD,AS1,AS2)}*C \textcircled{8}

Step 216 (S216): other different pairs of anchor stations are chosen as receivers, and the steps 201 to 215 are performed repeatedly.

In the implementation, the pair of anchor stations (i.e. anchor station_1 120B and anchor station_2 120C) are selected as two receivers in Steps 201 and 202, and Steps 208 and 209. In this step, another N−1 different pairs of anchor stations are chosen as N−1 pairs of receivers, for example, anchor station_0 120 A and anchor station_1 120B, or anchor station_0 120A and anchor station_2 120C, or other anchor stations which are not shown in FIG. 1. Just as an example, assuming anchor station_0 120 A and anchor station_1 120B are another pair of receivers, so an equation correspondingly can be obtained after performing the steps 201 to 215, which is shown as follows (C also denotes the speed of light):

\sqrt{(x−x₀)²+(y−y₀)²}−\sqrt{(x−x₁)²+(y−y₁)²}=ΔT_{air(MD,AS1,AS2)}*C \textcircled{9}

Step 217 (S217): The position of mobile device 110 is determined by the server 130 according to N compensated time difference of arrivals ΔT_{TOA_C(MD, ASi, ASj)}.

In the implementation, the position of mobile device 110 can be determined based on the equations \textcircled{8} and \textcircled{9}).

In order to reduce inaccurate estimation of the position of the mobile device, N different pair of anchor stations are chosen and N compensated time difference of arrivals ΔT_{TOA_C(MD, ASi,ASj)} can be thus determined. For example, when N is 3, such equations are determined as:

\sqrt{(x−x₁)²+(y−y₁)²}−\sqrt{(x−x₂)²+(y−y₂)²}=ΔT_{air(MD,AS1,AS2)}*C \textcircled{8}

\sqrt{(x−x₀)²+(y−y₀)²}−\sqrt{(x−x₁)²+(y−y₁)²}=ΔT_{air(MD,AS0,AS1)}*C \textcircled{9}

\sqrt{(x−x₀)²+(y−y₀)²}−\sqrt{(x−x₂)²+(y−y₂)²}=ΔT_{air(MD,AS0,AS2)}*C \textcircled{10}

The position of mobile device 110 can be determined based on N (e.g. N=3) equations according to a known linear least square algorithm (e.g., a weighted least square, WLS algorithm).

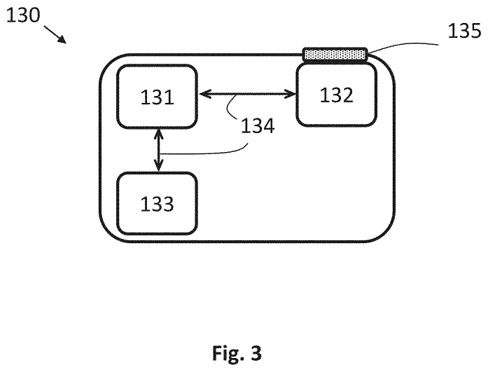

FIG. 3 shows a server 130 according to an embodiment of the disclosure. In the embodiment shown in FIG. 3, the server 130 comprises a processor 131, a transceiver 132 and a memory 133. The processor 131 is coupled to the transceiver 132 and the memory 133 by communication means 134 known in the art. As an alternative, the server 130 further comprises an antenna or antenna array 135 coupled to the transceiver 132, which means the server 130 is configured for wireless communications in a wireless communication system. As another alternative, the server 130 further comprises a wired interface 135 coupled to the transceiver 132, which means that the server 130 is configured for wired communications in a wired communication system.

The server 130 is configured to perform certain actions in this disclosure can be understood to mean that the server 130 comprises suitable means, such as e.g. the processor 131 and the transceiver 132, configured to perform said actions.

The mobile device 110 herein, may be denoted as a user device, a User Equipment (UE), an internet of things (IoT) device, a sensor device, a wireless terminal and/or a mobile terminal, is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via the radio access network, with another entity, such as another receiver or a server. The UE can be a Station (STA), which is any device that contains an IEEE 802.11-conformant Media Access Control (MAC) and Physical Layer (PHY) interface to the Wireless Medium (WM). The UE may also be configured for communication in 3GPP related LTE and LTE-Advanced, in WiMAX and its evolution, and in fifth generation wireless technologies, such as New Radio.

Anchor stations 120A-120C herein may also be denoted as a radio client device, an access client device, an access point, or a base station, e.g. a Radio Base Station (RBS), which in some networks may be referred to as transmitter, “gNB,” “gNodeB,” “eNB,” eNodeB,” “NodeB” or “B node,” depending on the technology and terminology used. The radio client devices may be of different classes such as e.g. macro eNodeB, home eNodeB or pico base station, based on transmission power and thereby also cell size. The radio client device can be a Station (STA), which is any device that contains an IEEE 802.11-conformant Media Access Control (MAC) and Physical Layer (PHY) interface to the Wireless Medium (WM). The radio client device may also be a base station corresponding to the fifth generation (5G) wireless systems.

Furthermore, any method according to embodiments of the disclosure may be implemented in a computer program, having code means, which when run by processing means causes the processing means to execute the steps of the method. The computer program is included in a computer readable medium of a computer program product. The computer readable medium may comprise essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, it is realized by the skilled person that embodiments of the mobile device 110 and anchor stations 120A-120C comprises the necessary communication capabilities in the form of, e.g., functions, means, units, elements, etc., for performing the solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, digital signal processors (DSPs), multi-stage decoding (MSDs), trellis-code modulation (TCM) encoder, TCM decoder, power supply units, power feeders, communication interfaces, communication protocols, etc. which are suitably arranged together for performing the solution.

Especially, the processor(s) of the mobile device 110 and anchor stations 120A-120C may comprise, e.g., one or more instances of a Central Processing Unit (CPU), a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the disclosure is not limited to the embodiments described above, but also relates to and incorporates all embodiments within the scope of the appended independent claims.

Although the exemplary embodiments of the present disclosure are disclosed herein, it should be noted that any various changes and modifications could be made in the embodiments of the present disclosure, without departing from the scope of legal protection which is defined by the appended claims. In the appended claims, the mention of elements in a singular form does not exclude the presence of the plurality of such elements, if not explicitly stated otherwise.

What is claimed is:

1. A method for locating a mobile device in a network system, the network system comprising a plurality of anchor stations, the method comprising the steps of:
for each pair of anchor stations Aᵢ and Aⱼ:
determining a receiver channel delay difference, Δ_{rx(A}_{ᵢ}_{,A}_{ⱼ}₎, of receiving times of a first signal transmitted by a different anchor station Aₖ and received at both anchor stations Aᵢ and Aⱼ, wherein i, j, k are integers, i, j, k≥1, and i≠j≠k;
determining a time difference of arrival, ΔT_{(MD,A}_{ᵢ}_{,A}_{ⱼ}₎, of receiving times of a second signal transmitted by the mobile device to the pair of anchor stations Aᵢ and Aⱼ; and
obtaining a compensated time difference of arrivals Comp_ΔT_{(MD,A}_{ᵢ}_{,A}_{ⱼ}₎ based on the time difference of arrival, ΔT_{(MD,A}_{ᵢ}_{,A}_{ⱼ}₎ and the receiver channel delay difference ΔT_{rx(A}_{ᵢ}_{,A}_{ⱼ}₎; and
determining a location of the mobile device based on the compensated time difference of arrivals Comp_ΔT_{(MD,A}_{ᵢ}_{,A}_{ⱼ}₎.

2. The method according to claim 1, wherein the step of determining a receiver channel delay difference ΔT_{rx(A}_{ᵢ}_{,A}_{ⱼ}₎ comprises:
receiving a pair of time of arrivals T_{(A}_{ₖ}_{,A}_{ᵢ}₎ and T_{(A}_{ₖ}_{,A}_{ⱼ}₎, wherein T_{(A}_{ₖ}_{,A}_{ᵢ}₎ and T_{(A}_{ₖ}_{,A}_{ⱼ}₎ specify receiving times of the first signal transmitted by anchor station Aₖ and received at anchor stations Aᵢ and Aⱼ respectively; and
determining the receiver channel delay difference ΔT_{rx(A}_{ᵢ}_{,A}_{ⱼ}₎ from the pair of received time of arrivals T_{(A}_{ₖ}_{,A}_{ᵢ}₎ and T_{(A}_{ₖ}_{,A}_{ⱼ}₎.

3. The method according to claim 1, wherein the step of determining a time difference of arrival, ΔT_{(MD,A}_{ᵢ}_{,A}_{ⱼ}₎ comprises:
receiving a pair of time of arrivals T_{(MD,A}_{ᵢ}₎ and T_{MD,A}_{ⱼ}₎ respectively from anchor stations Aᵢ and Aⱼ, wherein T_{(MD,A}_{ᵢ}₎ and T_{(MD,A}_{ⱼ}₎ specify receiving times of the second signal transmitted by the mobile device and received at the pair of anchor stations Aᵢ and Aⱼ respectively; and
determining the time difference of arrival ΔT_{(MD,A}_{ᵢ}_{,A}_{ⱼ}₎ from the pair of time of arrivals T_{(MD,A}_{ᵢ}₎ and T_{(MD,A}_{ⱼ}₎.

4. The method according to claim 1, wherein the step of obtaining a compensated time difference of arrivals Comp_ΔT_{(MD,A}_{ᵢ}_{,A}_{ⱼ}₎ comprises:
subtracting the receiver channel delay difference, ΔT_{rx(A}_{ᵢ}_{,A}_{ⱼ}₎ from the determined time difference of arrival ΔT_{(MD,A}_{ᵢ}_{,A}_{ⱼ}₎.

5. The method according to claim 1, wherein the step of determining the location of the mobile device based on the compensated time difference of arrivals Comp_ΔT_{(MD,A}_{ᵢ}_{,A}_{ⱼ}₎ comprises:
choosing N different pair of anchor stations from the plurality of anchor stations, wherein N is an integer and N≥2;
obtaining N compensated time difference of arrivals corresponding to the N different pair of anchor stations; and
determining the location of the mobile device based on the N compensated time difference of arrivals.

6. The method according to claim 1, wherein the first signal and the second signal are two different radio frequency signals.

7. An apparatus for locating a mobile device in a network system, wherein the network system comprises a plurality of anchor stations, the apparatus comprising:
at least one processor;
one or more memories coupled to the at least one processor and storing programming instructions for execution by the at least one processor, the programming instructions instructing the at least one processor to:
for each pair of anchor stations Aᵢ and Aⱼ:
determine a receiver channel delay difference, ΔT_{rx(A}_{ᵢ}_{,A}_{ⱼ}₎ of receiving times of a first signal transmitted by a different anchor station Aₖ and received at both anchor stations Aᵢ and Aⱼ, wherein i, j, k are integers, i, j, k≥1, and i≠j≠k;
determine a time difference of arrival, ΔT_{(MD,A}_{ᵢ}_{,A}_{ⱼ}₎ of receiving times of a second signal transmitted by the mobile device to the pair of anchor stations Aᵢ and Aⱼ; and
obtain a compensated time difference of arrivals Comp_ΔT_{(MD,A}_{ᵢ}_{,A}_{ⱼ}₎ based on the time difference of arrival, ΔT_{(MD,A}_{ᵢ}_{,A}_{ⱼ}₎ and the receiver channel delay difference ΔT_{rx(A}_{ᵢ}_{,A}_{ⱼ}₎; and
determine a location of the mobile device based on the compensated time difference of arrivals Comp_ΔT_{(MD,A}_{ᵢ}_{,A}_{ⱼ}₎.

8. The apparatus according to claim 7, wherein the programming instructions further instructing the at least one processor to:
receive a pair of time of arrivals T_{(A}_{ₖ}_{,A}_{ᵢ}₎ and T_{(A}_{ₖ}_{,A}_{ⱼ}₎, wherein T_{(A}_{ₖ}_{,A}_{ᵢ}₎ and T_{(A}_{ₖ}_{,A}_{ⱼ}₎ specify receiving times of the first signal transmitted by anchor station Aₖ and received at anchor stations Aᵢ and Aⱼ respectively; and
determine the receiver channel delay difference ΔT_{rx(A}_{ᵢ}_{,A}_{ⱼ}₎ from the pair of received time of arrivals T_{(A}_{ₖ}_{,A}_{ᵢ}₎ and T_{(A}_{ₖ}_{,A}_{ⱼ}₎.

9. The apparatus according to claim 7, wherein the programming instructions further instructing the at least one processor to:
receive a pair of time of arrivals T_{(MD,A}_{ᵢ}₎ and T_{(MD,A}_{ⱼ}₎ respectively from anchor stations Aᵢ and Aⱼ, wherein T_{(MD,A}_{ᵢ}₎ and T_{(MD,A}_{ⱼ}₎ specify receiving times of the second signal transmitted by the mobile device and received at the pair of anchor stations Aᵢ and Aⱼ respectively; and
determine the time difference of arrival ΔT_{(MD,A}_{ᵢ}_{,A}_{ⱼ}₎ from the pair of time of arrivals T_{(MD,A}_{ᵢ}₎ and T_{(MD,A}_{ⱼ}₎.

10. The apparatus according to claim 7, wherein the programming instructions further instructing the at least one processor to:
subtract the receiver channel delay difference, ΔT_{rx(A}_{ᵢ}_{,A}_{ⱼ}₎ from the determined time difference of arrival ΔT_{(MD,A}_{ᵢ}_{,A}_{ⱼ}₎.

11. The apparatus according to claim 7, wherein the programming instructions further instructing the at least one processor to:
choose N different pair of anchor stations from the plurality of anchor stations, wherein N is an integer and N≥2;
obtain N compensated time difference of arrivals corresponding to the N different pair of anchor stations; and
determine the location of the mobile device according to the N compensated time difference of arrivals.

12. The apparatus according to claim 7, wherein the first signal and the second signal are two radio frequency signals.

13. The apparatus according to claim 7, wherein the apparatus is a further anchor station Aₘ, with m≠i, j, k.

14. The apparatus according to claim 7, wherein the apparatus is one of anchor stations Aᵢ, Aⱼ, Aₖ.

15. A network system, wherein the network system comprises a plurality of anchor stations, at least one processor, and at least one or more memories coupled to the at least one processor and storing programming instructions for execution by the at least one processor, when executed by the at least one processor, cause the programming instructions instructing the at least one processor to:
for each pair of anchor stations Aᵢ and Aⱼ:
determine a receiver channel delay difference, ΔT_{rx(A}_{ᵢ}_{,A}_{ⱼ}₎ of receiving times of a first signal transmitted by a different anchor station Aₖ and received at both anchor stations Aᵢ and Aⱼ, wherein i, j, k are integers, i, j, k≥1 and i≠j≠k;
determine a time difference of arrival, ΔT_{(MD,A}_{ᵢ}_{,A}_{ⱼ}₎, of receiving times of a second signal transmitted by a mobile device to the pair of anchor stations Aᵢ and Aⱼ; and
obtain a compensated time difference of arrivals Comp_ΔT_{(MD,A}_{ᵢ}_{,A}_{ⱼ}₎ based on the time difference of arrival, ΔT_{(MD,A}_{ᵢ}_{,A}_{ⱼ}₎ and the receiver channel delay difference ΔT_{rx(A}_{ᵢ}_{,A}_{ⱼ}₎; and
determine a location of the mobile device based on the compensated time difference of arrivals Comp_ΔT_{(MD,A}_{ᵢ}_{,A}_{ⱼ}₎.

16. The network system, according to claim 15, wherein the programming instructions further instructing the at least one processor to:
receive a pair of time of arrivals T_{(A}_{ₖ}_{,A}_{ᵢ}₎ and T_{(A}_{ₖ}_{,A}_{ⱼ}₎, wherein T_{(A}_{ₖ}_{,A}_{ᵢ}₎ and T_{(A}_{ₖ}_{,A}_{ⱼ}₎ specify receiving times of the first signal transmitted by anchor station Aₖ and received at anchor stations Aᵢ and Aⱼ respectively; and
determine the receiver channel delay difference ΔT_{rx(A}_{ᵢ}_{,A}_{ⱼ}₎ from the pair of received time of arrivals T_{(A}_{ₖ}_{,A}_{ᵢ}₎ and T_{(A}_{ₖ}_{,A}_{ⱼ}₎.

17. The network system according to claim 15, wherein the programming instructions further instructing the at least one processor to:
receive a pair of time of arrivals T_{(MD,A}_{ᵢ}₎ and T_{(MD,A}_{ⱼ}₎ respectively from anchor stations Aᵢ and Aⱼ, wherein T_{(MD,A}_{ᵢ}₎ and T_{(MD,A}_{ⱼ}₎ specify receiving times of the second signal transmitted by the mobile device and received at the pair of anchor stations Aᵢ and Aⱼ respectively; and
determine the time difference of arrival ΔT_{(MD,A}_{ᵢ}_{,A}_{ⱼ}₎ from the pair of time of arrivals T_{(MD,A}_{ᵢ}₎ and T_{(MD,A}_{ⱼ}₎.

18. The network system according to claim 15, wherein the programming instructions further instructing the at least one processor to:
subtract the receiver channel delay difference, ΔT_{rx(A}_{ᵢ}_{,A}_{ⱼ}₎ from the determined time difference of arrival ΔT_{(MD,A}_{ᵢ}_{,A}_{ⱼ}₎.

19. The network system according to claim 15, wherein the programming instructions further instructing the at least one processor to:
choose N different pair of anchor stations from the plurality of anchor stations, wherein N is an integer and N≥2;
obtain N compensated time difference of arrivals corresponding to the N different pair of anchor stations; and
determine the location of the mobile device according to the N compensated time difference of arrivals.

20. The network system according to claim 15, wherein the first signal and the second signal are two radio frequency signals.
